(19) United States
(12) Patent Application Publication
(10) Pub. No.: US 2024/0369504 A1
(43) Pub. Date: Nov. 7, 2024

(54) INTEGRATED FESEM AND LDI-TOF-MS ANALYSIS SYSTEM

(71) Applicant: LG Energy Solution, Ltd., Seoul (KR)

(72) Inventors: Soeun KIM, Daejeon (KR); Yeu Young YOUN, Daejeon (KR); Minkyoung KIM, Daejeon (KR); Byung Joon CHAE, Daejeon (KR)

(21) Appl. No.: 18/688,499

(22) PCT Filed: Dec. 23, 2022
(86) PCT No.: PCT/KR2022/021138

§ 371 Date: Mar. 1, 2024

(30) Foreign Application Priority Data
May 3, 2022 (KR) 10-2022-0054691

(51) Int. Cl. G01N 23/2204; G01N 23/2251; H01J 49/16

(52) U.S. Cl. CPC G01N 23/2204; G01N 23/2251; H01J 49/164

(57) ABSTRACT

The present disclosure relates to an integrated FESEM and LDI-TOF-MS analysis system, and provides an integrated FESEM and LDI-TOF-MS analysis system that can perform FESEM analysis and LDI-TOF-MS analysis on a single sample to be analyzed without exposing the sample to the atmosphere.

### CROSS-REFERENCE TO RELATED APPLICATIONS

The present application is a National Phase entry pursuant to 35 U.S.C. § 371 of International Application No. PCT/KR2022/021138, filed on Dec. 23, 2022, and claims the benefit of and the priority to Korean Patent Application No. 10-2022-0054691, filed on May 3, 2022, the entire contents of which are hereby incorporated by reference in their entirety.

### TECHNICAL FIELD

The present disclosure relates to an FESEM and LDI-TOF-MS integrated analysis system, and to an FESEM and LDI-TOF-MS integrated analysis system capable of FESEM analysis and LDI-TOF-MS analysis while maintaining a state of non-exposure to an atmosphere for a single sample for analysis.

### BACKGROUND

Apparatuses for analyzing surfaces of a sample include FESEM and LDI-TOF-MS.

Unlike general scanning electron microscopes, the field-emission scanning electron microscope (FESEM) is an apparatus that injects accelerated electron beams from a field emission (FE) electron gun instead of a thermoelectron gun and detects signals such as secondary electrons, reflected electrons, and X-rays generated on the surfaces of the sample to display or record an enlarged image on a cathode-ray tube screen. By scanning the surface of the sample with fine electron beams in a two-dimensional x-y direction under a high-degree vacuum, it is possible to observe morphology of the sample and microstructures, especially the obtainable depth of focus of images is more than twice as that of optical microscopes, in addition to two times greater high resolution. In addition, it is possible to perform analysis on the surface morphology of the sample, microstructure observation, qualitative and quantitative analysis, distribution of constituting elements as well as identification of microcrystalline structures of the sample using EBSD, grain boundaries, and analysis on crystal orientation, while the surface is observable without coating a non-conductive sample with a low vacuum detector or low voltage.

Laser desorption/ionization-time of flight-mass spectrometry (LDI-TOF-MS) irradiates the sample with a laser, ionizes the sample, and then transfers the ionized sample to a flight tube. At this time, the ionized sample materials are separated by flight time according to the mass, and the time reaching a detector varies.

Since FESEM is designed to formally identify the morphology and element distribution of the sample surface while LDI-TOF-MS is to formally determine distribution of intramolecular compounds of the sample surface, analysis data provided by the two systems is different. In particular, since it is limited to view Li elements with FESEM, there is a limitation in identifying distribution of trace amounts of Li on the surface of an electrode sample.

FESEM and LDI-TOF-MS are independent analysis systems, in that conventional analysis using the same have required transfer of a sample between the two systems.

When the analysis is performed on the same sample by transferring between the two systems, the sample must be transferred to a sample plate of LDI-TOF-MS following the FESEM analysis, which caused damage to the sample. For example, for FESEM analysis, the sample may be immobilized with an adhesive material such as a double-sided tape on the sample plate for FESEM. In this case, in order to perform further analysis on the same sample with LDI-TOF-MS, the adhesive material-immobilized sample is detached from the sample plate for FESEM and then reattached to a separate sample plate for LDI-TOF-MS. During the process, the sample is damaged, which may have adverse effects on the analysis results. In particular, in the case of samples that need to be maintained under a state unexposed to the atmosphere, there has been difficulty in maintaining the state of non-exposure to the atmosphere in the process of loading the sample onto the LDI-TOF-MS system following the FESEM analysis.

In addition, since the sample is measured (electron, laser, etc.) by separate measurement means in the FESEM analysis system and the LDI-TOF-MS respectively while the sample is rearranged during the transfer of the sample, a method or apparatus for measuring the same position or area on the sample is required in an attempt to perform the analysis under the same condition in both analysis systems.

Therefore, required is a system which is capable of preventing damage to the sample during the transfer between the two systems and performing analysis under the same condition (maintaining the state unexposed to an atmosphere, matching of analysis areas, etc.).

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### Summary Technical Goals

The present disclosure relates to an FESEM and LDI-TOF-MS integrated analysis system, and an object of the present disclosure is to provide an FESEM and LDI-TOF-MS integrated analysis system capable of FESEM analysis and LDI-TOF-MS analysis while maintaining a state of non-exposure to the atmosphere for a single sample for analysis.

Technical objects to be achieved by the present disclosure are not limited to the technical problems mentioned above, and other technical objects not mentioned will be clearly understood from the description below by those of ordinary skill in the art to which the present disclosure pertains.

### Technical Solutions

An integrated analysis system of the present disclosure may include:
a first sample holder having a first closed space formed therein;
a second sample holder having a second closed space formed therein;
a first analyzing unit on which the first sample holder is mounted and in which a first analysis is performed on a sample for analysis;
a second analyzing unit on which the second sample holder is mounted and in which a second analysis is performed on the sample for analysis;
a sample plate mounted in the first closed space in the first sample holder or the second closed space in the second sample holder, wherein the sample for analysis is mounted on an upper surface of the sample plate; and
a glove box unit in which a sample transfer space is formed,
wherein the sample plate may be accommodated in one of the first closed space, the sample transfer space, and the second closed space in a state of non-exposure to the atmosphere, and in the sample transfer space, the sample plate is transferred from one of the first sample holder and the second sample holder to the other one.

### Advantageous Effects

In an FESEM and LDI-TOF-MS integrated analysis system of the present disclosure, in performing FESEM and LDI-TOF-MS analysis on a single sample, it is possible to keep an analyzing position on a sample, prevent damage to the sample during transfer, and maintain a state of non-exposure to the atmosphere.

The FESEM and LDI-TOF-MS integrated analysis system of the present disclosure may be capable of LDI-TOF-MS analysis on the same area on the sample that is analyzed via FESEM by positioning marking.

In the FESEM and LDI-TOF-MS integrated analysis system of the present disclosure, it may be easy to maintain a state of the sample, such as maintenance of a state of non-exposure to the atmosphere in the transfer between two systems.

### BRIEF DESCRIPTION OF DRAWINGS

FIGS. 1A to 1C are block diagrams illustrating an FESEM and LDI-TOF-MS integrated analysis system of the present disclosure.

FIG. 2 is a floor plan illustrating a sample plate.

FIG. 3 is an exploded perspective view illustrating a first holder.

FIG. 4 is a floor plan illustrating a mounting plate.

FIG. 5A is a front view illustrating a stopper.

FIG. 5B is a cross-sectional view illustrating a stopper.

FIG. 6 is a front view illustrating a knob.

FIG. 7 is a cross-sectional view illustrating a state in which a stopper and a knob are assembled.

FIGS. 8A and 8B are cross-sectional views illustrating a state in which a mounting plate and a stopper are assembled.

### DETAILED DESCRIPTION

An integrated analysis system of the present disclosure may include:
a first sample holder having a first closed space formed therein;
a second sample holder having a second closed space formed therein;
a first analyzing unit on which the first sample holder is mounted and in which a first analysis is performed on a sample for analysis;
a second analyzing unit on which the second sample holder is mounted and in which a second analysis is performed on the sample for analysis;
a sample plate mounted in the first closed space in the first sample holder or the second closed space in the second sample holder, wherein the sample for analysis is mounted on an upper surface of the sample plate; and
a glove box unit in which a sample transfer space is formed,
wherein the sample plate may be accommodated in one of the first closed space, the sample transfer space, and the second closed space in a state of non-exposure to the atmosphere, and in the sample transfer space, the sample plate is transferred from one of the first sample holder and the second sample holder to the other one.

In the integrated analysis system of the present disclosure, the sample plate may be provided in a shape of a disc, a fixing hole through which a fastener penetrates may be formed at a center of the sample plate, an alignment hole for alignment of the sample plate may be formed on the sample plate at a position spaced in a predetermined distance apart from the fixing hole, and a positioning marker for recognition of coordinate transformation between the first analyzing unit and the second analyzing unit may be formed on the upper surface of the sample plate at a position spaced in a predetermined distance apart from the fixing hole.

In the integrated analysis system of the present disclosure, a plurality of grid lines that intersect perpendicularly to each other may be formed on the upper surface of the sample plate.

In the integrated analysis system of the present disclosure, the first sample holder may include a body having an upper surface on which the sample plate is mounted; a lower housing in which a lower end of the body is accommodated such that an upper end of the body protrudes upward; and an upper housing configured to cover the upper surface of the body and coupled to an upper part of the lower housing to form the first closed space.

In the integrated analysis system of the present disclosure, a fixing groove into which the fastener is inserted may be formed on the upper surface of the body at a position facing the fixing hole, and a first alignment protrusion which is inserted into the alignment hole may be formed on the upper surface of the body at a position facing the alignment hole.

In the integrated analysis system of the present disclosure, the fastener may be provided as a bolt, threads may be formed on an inner circumferential surface of the fixing groove, and the fastener and the fixing groove may be screwed to fix the sample plate onto the upper surface of the body.

In the integrated analysis system of the present disclosure, the second sample holder may include a mounting plate having an upper surface on which the sample plate is mounted; a stopper coupled to the upper surface of the mounting plate to form the second closed space; and a knob detachably coupled to an upper end of the stopper.

In the integrated analysis system of the present disclosure, a sample mounting area on which the sample plate is mounted may be formed on the upper surface of the mounting plate, a stopper insertion groove into which a lower end of the stopper is inserted may be formed on the upper surface of the mounting plate, and the stopper insertion groove may be formed in a shape of a closed loop to surround the sample mounting area.

In the integrated analysis system of the present disclosure, a second alignment protrusion which is inserted into the alignment hole may be formed in the sample mounting area at a position facing the alignment hole.

In the integrated analysis system of the present disclosure, the sample plate may be formed of a ferromagnetic material, and a magnetic fixing part configured to fix the sample plate with a magnetic force may be provided in the sample mounting area.

In the integrated analysis system of the present disclosure, a sealing member insertion groove into which a sealing member that is formed of an elastic material is inserted may be formed on an outer circumferential surface of the stopper, and the sealing member may be in close contact with an inner wall of the stopper insertion groove.

In the integrated analysis system of the present disclosure, an identification step may be formed on the outer circumferential surface of the stopper above the sealing member insertion groove.

In the integrated analysis system of the present disclosure, a fastening bolt for coupling with the stopper may be formed at a lower end of the knob, a fastening groove into which the fastening bolt is inserted may be formed on an upper surface of the stopper, and the fastening bolt and the fastening groove may be screwed to each other.

In the integrated analysis system of the present disclosure, a vacuum vent hole configured to relieve a vacuum generated in the second closed space may be provided on the upper surface of the stopper.

Hereinafter, example embodiments according to the present disclosure will be described in detail with reference to the accompanying drawings. In this process, the size or shape of components shown in the drawings may be exaggerated for clarity and convenience of explanation. In addition, terms specifically defined in consideration of configurations and operations of the present disclosure may vary depending on the intention or custom of a user or operator. Definitions of these terms should be made based on the context throughout this specification.

In the description of the present disclosure, it should be noted that orientation or positional relationships indicated by the terms such as “center”, “upper”, “lower”, “left”, “right”, “vertical”, “horizontal”, “inside”, “outside”, “one side”, and “the other side” are based on orientation or positional relationships shown in the drawings or orientation or positional relationships usually of disposition when a product of the present disclosure is used, are merely for the description and brief illustration of the present disclosure, and should not be construed as limiting the present disclosure because they are not suggesting or implying that the indicated apparatus or element must be configured or operated in the specified orientation with the specified orientation.

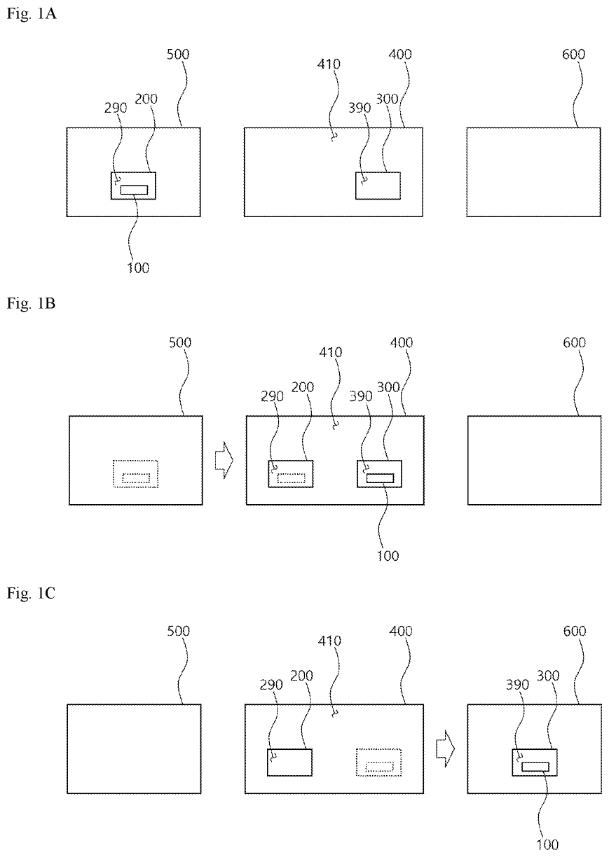

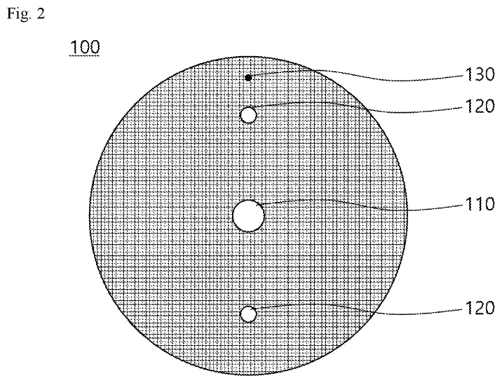

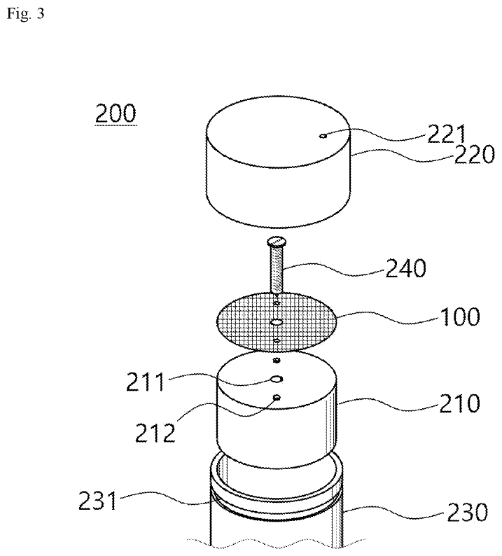

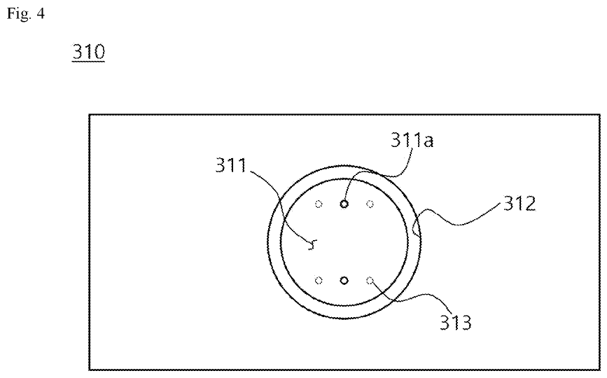

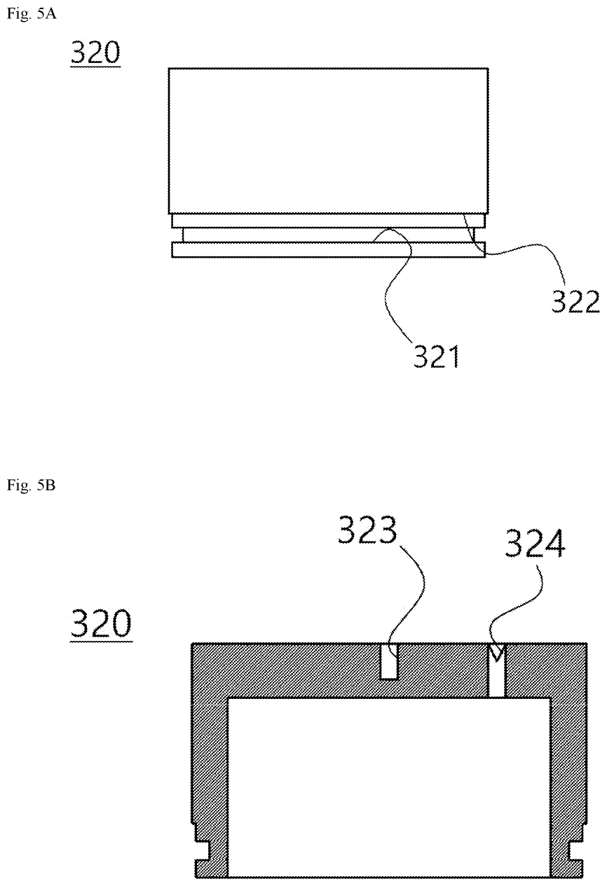

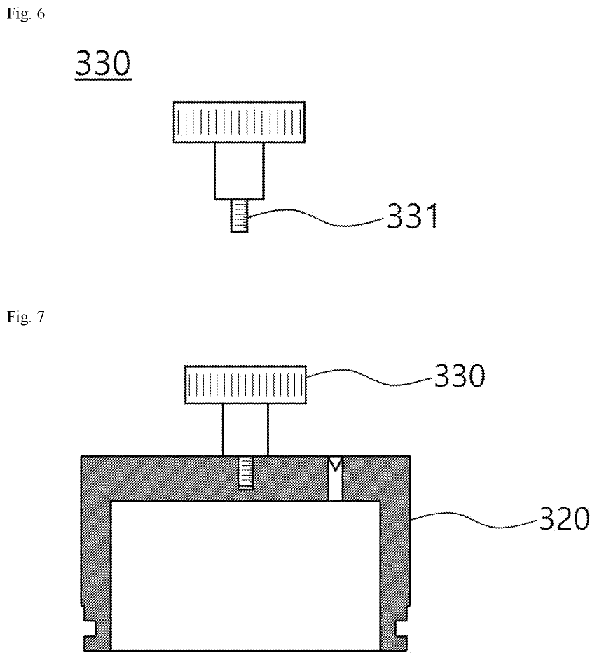

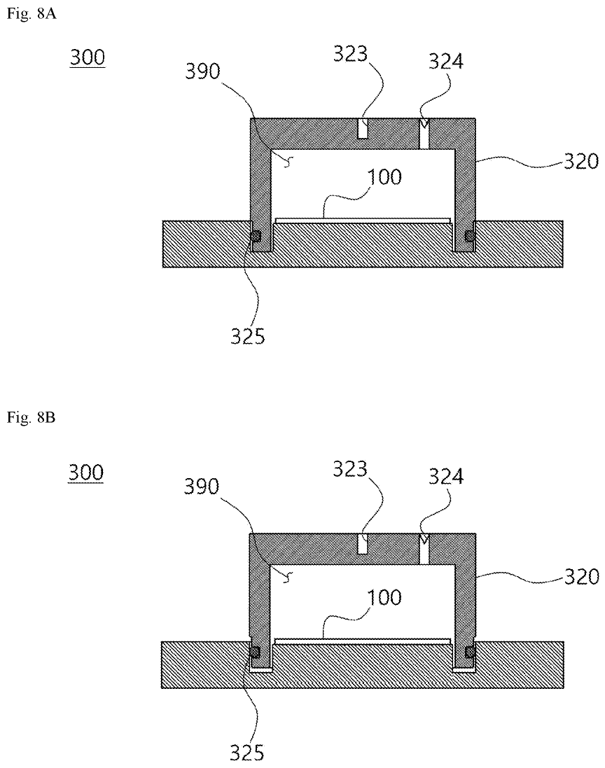

FIGS. 1A to 1C are block diagrams illustrating an FESEM and LDI-TOF-MS integrated analysis system of the present disclosure. FIG. 2 is a floor plan illustrating a sample plate 100. FIG. 3 is an exploded perspective view illustrating a first holder. FIG. 4 is a floor plan illustrating a mounting plate 310. FIG. 5A is a front view illustrating a stopper 320. FIG. 5B is a cross-sectional view illustrating the stopper 320. FIG. 6 is a front view illustrating a knob 330. FIG. 7 is a cross-sectional view illustrating a state in which the stopper 320 and the knob 330 are assembled. FIGS. 8A and 8B are cross-sectional views illustrating a state in which the mounting plate 310 and the stopper 320 are assembled.

Hereinafter, with reference to FIGS. 1A to 8B, the FESEM and LDI-TOF-MS integrated analysis system of the present disclosure will be described in detail.

In the process of sequentially performing FESEM and LDI-TOF-MS analyses, the FESEM and LDI-TOF-MS integrated analysis system of the present disclosure may prevent an sample for analysis from deteriorating, thereby making it possible to perform the two analyses under the same condition.

As shown in FIGS. 1A to 1C, the integrated analysis system of the present disclosure may include:
a first sample holder 200 having a first closed space 290 formed therein;
a second sample holder 300 having a second closed space 390 formed therein;
a first analyzing unit 500 on which the first sample holder 200 is mounted and in which a first analysis is performed on a sample for analysis;
a second analyzing unit 600 on which the second sample holder 300 is mounted and in which a second analysis is performed on the sample for analysis;
a sample plate 100 mounted in the first closed space 290 in the first sample holder 200 or the second closed space 390 in the second sample holder 300, wherein the sample for analysis is mounted on an upper surface of the sample plate 100; and
a glove box unit 400 in which a sample transfer space 410 is formed,
wherein the sample plate 100 may be accommodated in one of the first closed space 290, the sample transfer space 410, and the second closed space 390 in a state of non-exposure to the atmosphere, and separated from one of the first sample holder 200 and the second sample holder 300 inside the sample transfer space 410 so as to be mounted on the other one.

The first analyzing unit 500 may be a device for nondestructive analysis without damage to the sample during the analysis. The first analyzing unit 500 may be a device for FESEM analysis, FT-IR analysis, and XPS analysis. For example, when the first analyzing unit 500 is provided as an FESEM analysis device, the first analyzing unit 500 may be a JSM-7200F FESEM device of JEOL.

The second analyzing unit 600 may be both a nondestructive analysis device or a destructive analysis device regardless of sample damage during analysis. The second analyzing unit 600 may be a device for destructive analysis such as LDI-TOF-MS analysis, GD-MS analysis, LIBS analysis, and TOF-SIMS analysis, or nondestructive analysis such as FESEM analysis, FT-IR analysis, and XPS analysis. For example, when the second analyzing unit 600 is provided as an LDI-TOF-MS analysis device, it may be an IDSys Premier device of ASTA.

As shown in FIGS. 1A and 1B, the first sample holder 200 having the first closed space 290 formed therein may be loaded or unloaded on the first analyzing unit 500 while accommodating the sample plate 100 in the first closed space 290.

As shown in FIGS. 1B and 1C, the second sample holder 300 having the second closed space 390 formed therein may be loaded and unloaded on the second analyzing unit 600 while accommodating the sample plate 100 in the second closed space 390.

As shown in FIG. 1B, the process of mounting or separating the sample plate 100 to and from the first sample holder 200 or the second sample holder 300 is carried out in the sample for analysis transfer space 410 of the glove box unit 400 where a vacuum state is maintained, such that the sample for analysis in the FESEM and LDI-TOF-MS integrated analysis system of the present disclosure may be kept under a state of non-exposure to the atmosphere and transferred between the two systems.

As shown in FIG. 2, the sample plate 100 may be provided in a shape of a disc, a fixing hole 110 through which a fastener 240 penetrates may be formed at a center of the sample plate 100, an alignment hole 120 for alignment of the sample plate 100 may be formed in the sample plate 100 at a position spaced in a predetermined distance apart from the fixing hole 110, and a positioning marker for recognition of coordinate transformation between the first analyzing unit 500 and the second analyzing unit 600 may be formed on the upper surface of the sample plate 100 at a position spaced in a predetermined distance apart from the fixing hole 110.

The sample for analysis may be fixed onto the upper surface of the sample plate 100 at a predetermined position by an adhesive tape.

A plurality of alignment holes 120 may be provided, and more specifically, each alignment hole 120 may be spaced apart from each other with the fixed hole 110 interposed therebetween. For example, two alignment holes may be provided to be spaced apart from each other with the fixed hole 110 interposed therebetween on an imaginary straight line that passes through the center of the sample plate 100.

The positioning marker may be formed of a material recognizable by an optical sensor, an image sensor, and a camera. The first analyzing unit 500 and the second analyzing unit 600 may be provided with the optical sensor, the image sensor, and the camera configured to recognize coordinates between a position of the positioning marker and that of the fixing hole 110 on a two-dimensional plane formed on the upper surface of the sample plate 100.

Therefore, when the coordinate information between the two points described above and a point at which the measurement is performed is passed to the second analyzing unit 600 after sample analysis in the first analyzing unit 500, the second analyzing unit 600 may detect the position of a marker and the position of the fixed hole 110, and then the position where the measurement is performed in the first analyzing unit 500 may be calculated based on the coordinate information that is input from the first analyzing unit 500.

On the upper surface of the sample plate 100, a plurality of grid lines intersecting perpendicularly to each other may be formed.

As shown in FIG. 3, the first sample holder 200 may include a body 210 having an upper surface on which the sample plate 100 is mounted; a lower housing 230 in which a lower end of the body 210 is accommodated such that an upper end of the body 210 protrudes to an upper part; and an upper housing 220 configured to cover the upper surface of the body 210 and coupled to an upper part of the lower housing 230 to form the first closed space 290.

A fixing groove 211 into which the fastener 240 is inserted may be formed on the upper surface of the body 210 at a position facing the fixing hole 110, and a first alignment protrusion 212 inserted into the alignment hole 120 may be formed on the upper surface of the body 210 at a position facing the alignment hole 120.

For example, the body 210 may be provided in a cylindrical shape, and the fixing groove 211 may be positioned at the center of the upper surface of the body 210 that is formed in a circular shape.

The fastener 240 may be provided as a bolt, threads may be formed on an inner circumferential surface of the fixing groove 211, and the fastener 240 and the fixing groove 211 may be screwed to fix the sample plate 100 onto the upper surface of the body 210. Since the first alignment protrusion 212 is inserted into the alignment hole 120, it is possible to prevent rotation of the sample plate 100 along with the fastener 240 in the process of bolting the fastener 240 to the fixing groove 211.

The lower housing 230 may be provided as a cylindrical container with an upper part opened. An outer circumferential surface of the body 210 may be in close contact with an inner circumferential surface of the lower housing 230.

On an outer circumferential surface of the lower housing 230, a groove 231 for inserting an O-ring for sealing may be formed. The O-ring may be in close contact with the outer circumferential surface of the lower housing 230 and an inner circumferential surface of the upper housing 220, and the lower housing 230 and the upper housing 220 may be coupled, such that it is possible to increase airtightness of the formed first closed space 290.

The upper housing 220 may also be provided in a cylindrical shape and may be a container with a lower part opened. An inner diameter of the upper housing 220 may be formed to be greater than an outer diameter of the lower housing 230, and the upper housing 220 may be configured to cover the upper part of the lower housing 230, thereby forming the first closed space 290.

On an upper surface of the upper housing 220, a ventilation hole 221 configured to relieve a vacuum in the first closed space 290 upon separation between the upper housing 220 and the lower housing 230 may be formed.

As shown in FIGS. 4 to 8B, the second sample holder 300 may include a mounting plate 310 having an upper surface on which the sample plate 100 is mounted; a stopper 320 coupled to the upper surface of the mounting plate 310 to form the second closed space 390; and a knob 330 detachably coupled to an upper end of the stopper 320.

As shown in FIG. 4, a sample mounting area 311 on which the sample plate 100 is mounted may be formed on the upper surface of the mounting plate 310, a stopper insertion groove 312 into which a lower end of the stopper 320 is inserted may be formed on the upper surface of the mounting plate 310, and the stopper insertion groove 312 may be formed by surrounding the sample mounting area 311 in a closed loop shape.

An inlet provided in the second analyzing unit 600 for entering of the second sample holder 300 into a measurement space formed inside the second analyzing unit 600 may be formed in a slit shape. Thus, the second sample holder 300 may be provided in a form that is thinner than a width of a slit-type inlet provided in the second analyzing unit 600. Specifically, the mounting plate 310, which is a body of the second sample holder 300, may be formed in a shape of a flat plate.

The sample mounting area 311 may be provided in a shape corresponding to the sample plate 100. That is, since the sample plate 100 is provided in a shape of a disc, the sample mounting area 311 may be provided in a circular shape.

In the sample mounting area 311, a second alignment protrusion 311a inserted into the alignment hole 120 may be formed at a position facing the alignment hole 120. The sample plate 100 may be mounted in position on the sample mounting area 311 by the second alignment protrusion 311a. The second alignment protrusion 311a may be provided to correspond to the position and number of alignment holes 120. For example, if two alignment holes 120 are provided, two second alignment protrusions 311a may also be provided, so that each of the two second alignment protrusions 311a may be positioned respectively to face the position of each of the two alignment holes 120.

The sample plate 100 may be formed of a ferromagnetic material, and a magnetic fixing part 313 configured to fix the sample plate 100 with a magnetic force may be provided in the sample mounting area 311. The magnetic fixing part 313 may be provided in a state completely embedded in the upper surface of the mounting plate 310 so as not to protrude on the sample mounting area 311.

A plurality of magnetic fixing parts 313 may be provided. For example, the magnetic fixing part 313 may be provided in the two times greater number than that of the second alignment protrusions 311a, and a pair of magnetic fixing parts 313 may be spaced apart from each other with the second alignment protrusion 311a interposed therebetween. For example, four magnetic fixing parts 313 may be provided.

As shown in FIGS. 5A and 5B, a sealing member insertion groove 321 into which a sealing member 325 that is formed of an elastic material is inserted may be formed on an outer circumferential surface of the stopper 320, and the sealing member 325 may be in close contact with an inner wall of the stopper insertion groove 312. Specifically, the sealing member 325 may be in close contact with the inner wall of the stopper insertion groove 312 while being inserted into the sealing member insertion groove 321. In other words, as shown in FIGS. 8A and 8B, in a state in which the outer circumferential surface of the stopper 320 and the inner wall of the stopper insertion groove 312 face each other, the sealing member 325 may be interposed therebetween.

On the outer circumferential surface of the stopper 320, an identification step 322 may be formed above the sealing member insertion groove 321. The identification step 322 may be configured for visual identification of a coupling state of the stopper 320. As shown in FIG. 8B, if the stopper 320 is not inserted all the way into the stopper insertion groove 312, the identification step 322 is visually identified, making it noticeable that the stopper 320 is not fully coupled to the mounting plate 310. As shown in FIG. 8A, if the stopper 320 is completely coupled to the mounting plate 310, the identification step 322 disappears from the view to be recognized that the complete coupling is made. As described above, since an inlet of the second analyzing unit 600 is formed in the form of a slit, incomplete coupling of the stopper 320 may cause a problem in the loading of the second sample holder 300 in the second analyzing unit 600. The identification step 322 may prevent the problem.

On an upper surface of the stopper 320, a vacuum vent hole 324 configured to relieve a vacuum formed in the second closed space 390 may be provided.

As shown in FIG. 6, a fastening bolt 331 configured for coupling with the stopper 320 may be formed at a lower end of the knob 330, a fastening groove 323 into which the fastening bolt 331 is inserted may be formed on the upper surface of the stopper 320, and the fastening bolt 331 and the fastening groove 323 may be screwed to each other. As described above, the stopper 320 has a height limit, which may cause difficulty in separating the stopper 320. Therefore, when separating the stopper 320 from the mounting plate 310, by mounting the knob 330 to the stopper 320, it is possible to easily separate the stopper 320 from the mounting plate 310.

Although the example embodiments according to the present disclosure have been described above, these are merely exemplary, and those skilled in the art will understand that various modifications and equivalent ranges of the example embodiments are possible therefrom. Accordingly, the scope for true technical protection of the present disclosure should be defined by the appended claims.

### DESCRIPTION OF SYMBOLS

100 . . . Sample plate, 110 . . . Fixing hole, 120 . . . Alignment hole, 130 . . . Positioning marker, 140 . . . Grid line, 200 . . . First sample holder, 210 . . . Body, 211 . . . Fixing groove, 212 . . . First alignment protrusion, 220 . . . Upper housing, 230 . . . Lower housing, 240 . . . Fastener, 290 . . . First closed space, 300 . . . Second sample holder, 310 . . . Mounting plate, 311 . . . Sample mounting area, 311a . . . Second alignment protrusion, 312 . . . Stopper insertion groove, 313 . . . Magnetic fixing part, 320 . . . Stopper, 321 . . . Sealing member insertion groove, 322 . . . Identification step, 323 . . . Fastening groove, 324 . . . Vacuum vent hole, 325 . . . Sealing member, 330 . . . Knob, 331 . . . Fastening bolt, 390 . . . Second closed space, 400 . . . Glove box unit, 410 . . . Sample transfer space, 500 . . . First analyzing unit, 600 . . . Second analyzing unit

### INDUSTRIAL APPLICABILITY

In an FESEM and LDI-TOF-MS integrated analysis system of the present disclosure, in performing FESEM and LDI-TOF-MS analysis on a single sample, it is possible to keep an analyzing position on a sample, prevent damage to the sample during the transfer, and maintain a state of non-exposure to the atmosphere.

The FESEM and LDI-TOF-MS integrated analysis system of the present disclosure may be capable of LDI-TOF-MS analysis on the same area on the sample that is analyzed via FESEM by positioning marking.

In the FESEM and LDI-TOF-MS integrated analysis system of the present disclosure, it may be easy to maintain a state of the sample, such as maintenance of a state of non-exposure to the atmosphere in the transfer between two systems.

What is claimed is:

1. An integrated analysis system, comprising:
a first sample holder having a first closed space formed therein;
a second sample holder having a second closed space formed therein;
a first analyzing unit on which the first sample holder is mounted and in which a first analysis is performed on a sample for analysis;
a second analyzing unit on which the second sample holder is mounted and in which a second analysis is performed on the sample for analysis;
a sample plate mounted in the first closed space in the first sample holder or the second closed space in the second sample holder, wherein the sample for analysis is mounted on an upper surface of the sample plate; and
a glove box unit in which a sample transfer space is formed,
wherein the sample plate is accommodated in one of the first closed space, the sample transfer space, and the second closed space in a state of non-exposure to an atmosphere, and in the sample transfer space, the sample plate is transferred from one of the first sample holder and the second sample holder to the other one.

2. The integrated analysis system of claim 1, wherein:
the sample plate has a shape of a disc,
a fixing hole through which a fastener penetrates is formed at a center of the sample plate,
an alignment hole for alignment of the sample plate is formed on the sample plate at a position spaced in a first predetermined distance apart from the fixing hole, and
a positioning marker for recognition of coordinate transformation between the first analyzing unit and the second analyzing unit is formed on the upper surface of the sample plate at a position spaced in a second predetermined distance apart from the fixing hole.

3. The integrated analysis system of claim 2, wherein a plurality of grid lines that intersect perpendicularly to each other are formed on the upper surface of the sample plate.

4. The integrated analysis system of claim 2, wherein the first sample holder comprises:
a body having an upper surface on which the sample plate is mounted;
a lower housing in which a lower end of the body is accommodated such that an upper end of the body protrudes upward; and
an upper housing configured to cover the upper surface of the body and coupled to an upper part of the lower housing to form the first closed space.

5. The integrated analysis system of claim 4, wherein:
a fixing groove into which the fastener is inserted is formed on the upper surface of the body at a position facing the fixing hole, and
a first alignment protrusion which is inserted into the alignment hole is formed on the upper surface of the body at a position facing the alignment hole.

6. The integrated analysis system of claim 5, wherein:
the fastener is a bolt,
threads are formed on an inner circumferential surface of the fixing groove, and
the fastener and the fixing groove are screwed to fix the sample plate onto the upper surface of the body.

7. The integrated analysis system of claim 4, wherein the second sample holder comprises:
a mounting plate having an upper surface on which the sample plate is mounted;
a stopper coupled to the upper surface of the mounting plate to form the second closed space; and
a knob detachably coupled to an upper end of the stopper.

8. The integrated analysis system of claim 7, wherein;
a sample mounting area on which the sample plate is mounted is formed on the upper surface of the mounting plate,
a stopper insertion groove into which a lower end of the stopper is inserted is formed on the upper surface of the mounting plate, and
the stopper insertion groove is formed in a shape of a closed loop to surround the sample mounting area.

9. The integrated analysis system of claim 8, wherein a second alignment protrusion which is inserted into the alignment hole is formed in the sample mounting area at a position facing the alignment hole.

10. The integrated analysis system of claim 8, wherein;
the sample plate is formed of a ferromagnetic material, and
a magnetic fixing part configured to fix the sample plate with a magnetic force is provided in the sample mounting area.

11. The integrated analysis system of claim 8, wherein;
a sealing member insertion groove into which a sealing member that is formed of an elastic material is inserted is formed on an outer circumferential surface of the stopper, and
the sealing member is in close contact with an inner wall of the stopper insertion groove.

12. The integrated analysis system of claim 11, wherein an identification step is formed on the outer circumferential surface of the stopper above the sealing member insertion groove.

13. The integrated analysis system of claim 7, wherein;
a fastening bolt for coupling with the stopper is formed at a lower end of the knob,
a fastening groove into which the fastening bolt is inserted is formed on an upper surface of the stopper, and
the fastening bolt and the fastening groove are screwed to each other.

14. The integrated analysis system of claim 7, wherein a vacuum vent hole configured to relieve a vacuum generated in the second closed space is provided on an upper surface of the stopper.
